(19) United States
(12) Patent Application Publication
(10) Pub. No.: US 2026/0167432 A1
(43) Pub. Date: Jun. 18, 2026

(54) Conveyor Belt Scraper Assembly

(71) Applicant: Mark Gilbert IP Pty Ltd, Bucasia (AU)

(72) Inventor: Mark Gilbert, Bucasia (AU)

(21) Appl. No.: 19/124,310

(22) PCT Filed: Jun. 27, 2023
(86) PCT No.: PCT/AU2023/050586

§ 371 Date: Apr. 25, 2025

(30) Foreign Application Priority Data
Oct. 27, 2022 (AU) 2022903177

(51) Int. Cl. B65G 45/16

(52) U.S. Cl. CPC B65G 45/16

(57) ABSTRACT

A conveyor belt scraper assembly is provided. The conveyor belt scraper assembly includes one or more scrapers supported by a support. The assembly includes a scraper realignment configured to move at least one of the one or more scrapers, from a first state to a second state, wherein movement of said at least one of the one or more scrapers can be in a translational direction and a rotational direction. A method of operating a conveyor belt assembly is also provided.

### FIELD OF THE INVENTION

The present disclosure relates to a conveyor belt scraper assembly. In particular, the present invention relates to a conveyor belt scraper assembly for use with coal, various ores, or minerals. However, it will be appreciated by those skilled in the art that the conveyor belt scraper assembly can be applied to other applications and industries.

### BACKGROUND OF THE INVENTION

Coal is generally extracted by either underground mining operations, or open-cut mining operations. After extraction of the raw coal, it is necessary to process the raw coal into final products depending on the intended market, and the quality and composition of the raw coal. Typical processing includes crushing to a uniform size and beneficiation. Beneficiation may include washing and other processes to remove ash, sulphur, and rock particles. Coal has properties which dictate that coal particles and/or coal slurry are particularly susceptible to sticking to conveyor belts, especially at certain moisture levels.

During processing, and/or transportation, it is common for the coal to be transported on conveyor belts between locations, and between process stages. It is typical for some coal to become stuck to the belt. This is especially common when the coal is wet or has been wet during beneficiation. It is important to remove any coal from the conveyor belt that becomes adhered to the belt. This is important to prevent the coal from damaging any drive machinery located on the underside of the belt. This is also important to improve conveyor belt efficiency to ensure most of the material is unloaded. Furthermore, any coal or sludge which proceeds to the underside of the conveyor belt can be difficult to access and hence remove later.

In order to remove excess coal, which has not fallen off the conveyor due to gravity as the conveyor belt changes directions, conveyor scrapers are often installed on the underside of the conveyor belt, adjacent to a roller which normally directs the belt around 180 degrees. The conveyor scraper is generally in the form of a metal blade, which scrapes across the surface of the conveyor belt, physically scraping any coal from the surface. The scraped coal is caught and returned to the processing line.

In a typical conveyor belt installation, there are two sets of scrapers, namely primary and secondary scrapers. The primary scrapers are located near the location where the conveyor belt changes direction, and these scrapers remove the bulk of the material which is stuck to the belt. On the underside of the belt, secondary scrapers may be deployed to subsequently clean any material that was not removed by the primary scrapers.

Whilst the process has been described with application to coal processing, it will be appreciated that it is applicable to processing other minerals, and use in other industries such as food processing, agriculture, etc.

There are several drawbacks associated with existing scraper blades. One issue concerns the scraper blades being destroyed or at least damaged by the coal. To extend the life of the scraper blades, some scraper blades are manufactured with resilient zones intended to elastically deform when the metal scraper tip encounters an obstruction.

Such resilient blades are known to still suffer from damage during use because of the large loads that may be applied, and owing to the limited amount of elastic deformability.

The process of replacing damaged scraper blades generally requires the conveyor belt to be stopped, which accordingly requires the coal processing or transportation to be temporarily halted. This can be costly due to replacement scraper blade costs, labour, and undesirable process downtime.

When replacing the scraper blade, it is often necessary for a technician to work in the zone located in front of the conveyor belt, or beneath the conveyor belt. This is generally undesirable as the technician could be injured by unstable material, which may fall from the conveyor belt unexpectedly. In addition, this zone is often very slippery due to liquid that has fallen from the underside of the belt on the return path.

Accordingly, existing scraper blades suffer from undesired damage and hence reduced longevity during use. In addition, their replacement and maintenance can be challenging.

A further issue relates to scraper blades being displaced from their pre-set operational state. This can result in reduced efficiency due to the blade being positioned and/or oriented in a sub-optimal manner relative to the conveyor belt.

It is desirable for at least one embodiment of the present invention to obviate at least one of the above drawbacks, or provide a useful alternative.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides a conveyor belt scraper assembly, including:
one or more scrapers;
a support configured to support said one or more scrapers;
a scraper realignment system configured to move at least one of the one or more scrapers, from a first state to a second state, wherein movement of said at least one of the one or more scrapers can be in a substantially translational direction and a substantially rotational direction.

The support may be configured to support said one or more scrapers in the first state. In an embodiment, the first state is a first pre-set operative state of said one or more scrapers and the second state is an altered state of said one or more scrapers, wherein said altered state is a second operative state of said one or more scrapers.

The support may be configured to support said one or more scrapers in the second state. The second state may be a pre-set operative state of said one or more scrapers and the first state may be an altered state of said one or more scrapers, wherein said altered state is a disrupted state of said one or more scrapers.

In an embodiment, the scraper realignment system is configured to move the at least one of the one or more scrapers, from the disrupted state to the pre-set operative state and/or from the first pre-set operative state to the second operative state.

Advantageously, in an embodiment the present invention enables at least one of the one or more scrapers to be moved back to its pre-set operative state when the scraper is in the disrupted state. Such disruption can occur when a large load is imparted on the scraper, thereby causing the scraper to displace from its pre-set operative state. In particular, the scraper realignment system is capable of moving the scraper in a translational direction and a rotational direction depending on what is required to move the scraper from the disrupted state to the pre-set operative state. For example, in order to move the scraper from the altered state to the pre-set operative state, the realignment system may move the scraper in a translational direction, a rotational direction or both a translational direction and rotational direction. In this respect, the realignment system can be considered to act ‘reactively’ when the at least one of the one or more scraper blades is disrupted (i.e. moved to the disrupted state).

A further advantage of the present invention is that it enables at least one of the one or more scrapers to be moved from its first pre-set operative state to the second operative state. Such alteration can occur when operational conditions indicate that the first pre-set operative state is no longer suitable or preferred for the given operational conditions. The scraper realignment system is capable of moving the scraper in a translational direction and rotational direction from the first pre-set operative state to the second operative state. For example, in order to move the scraper from the first pre-set operative state to the second operative state, the scraper realignment system may move the scraper in a translational direction, a rotational direction or both a translational direction and rotational direction. In this respect, the realignment system can be considered to act ‘proactively’ to move the at least one of the one or more scraper blades to the second operative state. Preferably, the scraper is moved in the rotational direction from the first pre-set operative state to the second operative state.

It will be understood that the state of the one or more scrapers refers to the position and/or the orientation of the scraper(s).

Preferably, the conveyor belt scraper assembly includes a plurality of scrapers and the support is configured to support said plurality of scrapers. The scraper realignment system is preferably configured to move the plurality of scrapers from the first state to the second state. In an embodiment, the first state may be the first pre-set operative state of the plurality of scrapers and the second state is the second operative state of the plurality of scrapers. In another embodiment, the second state may be a pre-set operative state of the plurality of scrapers and the first state may be the disrupted state of said plurality of scrapers.

It will be appreciated that the first pre-set operative state and the pre-set operative state herein refer to an initial pre-set operative state of the one or more scrapers.

The initial pre-set operative state of the one or more scrapers may include a first desired position and/or a first desired orientation of the one or more scrapers. The first desired position of the one or more scrapers may be a predetermined position, whereby the one or more scrapers contact the conveyor belt in a desired manner (e.g. to provide the desired engagement between the one or more scrapers and the conveyor belt). The first desired orientation of the one or more scrapers may be defined by the scraper being oriented at a predetermined angle relative to the conveyor belt. The rotational direction is preferably about an axis substantially perpendicular to a direction of travel of the conveyor belt. The translational direction is preferably a direction substantially along an axis extending to and away from the conveyor belt.

In an embodiment where the one or more scrapers are secondary scrapers of the conveyor belt scraper assembly, the first desired position of the one or more scrapers is a predetermined position below a conveyor belt. In another embodiment, the first desired position of the one or more scrapers is a predetermined position, whereby the one or more scrapers contact the conveyor belt in a desired manner (e.g. to provide the desired engagement between the one or more scrapers and the conveyor belt). In an embodiment where the one or more scrapers are secondary scrapers of the conveyor belt scraper assembly, the first desired orientation of the one or more scrapers is defined by the scraper being oriented at a predetermined angle relative to the conveyor belt. Preferably, the predetermined angle of the scraper is between about 85° and 95° with respect to the conveyor belt.

It will be appreciated that the altered state herein can refer to either of the disrupted state or the second operative state of the one or more scrapers depending on the nature of the alteration.

The altered state of the one or more scrapers may include a second, altered position and/or a second, altered orientation of the one or more scrapers. The second, altered position of the one or more scrapers may be a position translationally displaced from the first desired position. The second, altered orientation of the one or more scrapers may be defined by the scraper being angularly displaced from the predetermined angle.

In an embodiment where the one or more scrapers are secondary scrapers of the conveyor belt scraper assembly, the second, altered position of the one or more scrapers is a position substantially vertically displaced from the first desired position. In an embodiment where the one or more scrapers are secondary scrapers of the conveyor belt scraper assembly, the second, altered orientation of the one or more scrapers is defined by the scraper being substantially angularly displaced from the predetermined angle.

In an embodiment, the support is a bar or shaft. The one or more scrapers may be directly mounted to the support. Alternatively, the one or more scrapers may be mounted to a mounting cartridge, wherein the mounting cartridge is directly or indirectly mounted to the support. The support may include a plurality of support sections configured to be connected end to end with other like support sections. The rotational direction is preferably about an axis substantially parallel to a longitudinal axis of the support. Preferably, the one or more scrapers move in rotational relation with the support.

In an embodiment, said scraper realignment system is configured to move the support, thereby moving the at least one of the one or more scrapers from a first state to a second state. Movement of said support may be in a substantially translational direction and/or a substantially rotational direction.

The scraper realignment system may include a damping system. The damping system may be configured to move the at least one of the one or more scrapers from the disrupted state to or towards the pre-set operative state, wherein said movement of said at least one of the one or more scrapers is in the translational direction (or substantially in the translational direction). In another embodiment, the damping system may be configured to move the at least one of the one or more scrapers from the first pre-set operative state to or towards the second operative state, wherein said movement of said at least one of the one or more scrapers is in the translational direction (or substantially in the translational direction). The damping system is preferably resiliently secured to the support, thereby enabling the support (and thus the at least one of the one or more scrapers) to be temporarily displaced if a large load is applied to the at least one of the one or more scrapers, and to move the at least one of the one or more scrapers back to or towards the pre-set operative state from the disrupted state. Advantageously, this temporary displacement reduces the likelihood of damage to the scraper (particularly the blade of the scraper). A further advantage is that the at least one of the one or more scrapers is translated back towards the first desired position such that scraper can continue to operate in this position relative to the conveyor belt. It will be appreciated that what is described with respect to the at least one of the one or more scrapers can also apply to the plurality of scrapers (i.e. the plurality of scrapers may be together moved from the first state to the second state).

The damping system may include one or more springs. Alternatively, or in addition, the damping system may include an air cushioning system.

The scraper realignment system may include an actuator. The actuator may be configured to move the at least one of the one or more scrapers from the first state to the second state. In an embodiment, the actuator is configured to move the at least one of the one or more scrapers from the disrupted state to or towards the pre-set operative state, wherein movement of said at least one of the one or more scrapers is in the rotational direction (or substantially in the rotational direction). In another embodiment, the actuator is configured to move the at least one of the one or more scrapers from the first pre-set operative state to or towards the second operative state, wherein movement of said at least one of the one or more scrapers is in the rotational direction (or substantially in the rotational direction). In another embodiment, the actuator is configured to move the at least one of the one or more scrapers from the disrupted state to or towards the pre-set operative state, and further configured to move the at least one of the one or more scrapers from the first pre-set operative state to or towards the second operative state, wherein movement of said at least one of the one or more scrapers is in the rotational direction (or substantially in the rotational direction). The actuator is preferably operatively secured to the support. This can enable the support (and thus the at least one of the one or more scrapers) to be temporarily angularly displaced if a large load is applied to the at least one of the one or more scrapers, and to move the at least one of the one or more scrapers back to or towards the pre-set operative state from the disrupted state. This can also enable the support (and thus the at least one of the one or more scrapers) to be angularly displaced to move the at least one of the one or more scrapers from the first pre-set operative state to the second operative state. Advantageously, the temporary displacement reduces the likelihood of damage to the scraper (particularly the blade of the scraper). A further advantage is that the at least one of the one or more scrapers can be reoriented back towards the first desired orientation such that scraper can operate in this orientation with respect to the conveyor belt or oriented towards the second, altered orientation such that scraper can operate in this orientation with respect to the conveyor belt. It will be appreciated that what is described with respect to the at least one of the one or more scrapers can also apply to the plurality of scrapers (i.e. the plurality of scrapers may be together moved from the first state to the second state).

The actuator may include one or more of an electrical actuator, a pneumatic actuator or a hydraulic actuator. However, other suitable actuator types may also be used. Preferably, the actuator is a rotary actuator, such as a rotary vane actuator.

The scraper realignment system may further include a controller operatively associated with the actuator. The controller is preferably a PLC controller with PID control, although other types of controllers and control may be used.

In an embodiment, the controller is configured to receive at least one input signal, said at least one input signal relating to one or more of: conveyor belt speed, presence of material on conveyor belt, vibration of scraper, and pressure on scraper. In an embodiment, the controller is configured to transmit at least one output signal based on said at least one input signal, said at least one output signal causing a change in the first state of at least one of the one or more scrapers to the second state. In other words, said at least one output signal causes at least one of the one or more scrapers to move from the first state to the second state. In an embodiment, said at least one output signal causes a change from the first pre-set operative state of the at least one of the one or more scrapers to the second operative state. In other words, said at least one output signal causes the at least one of the one or more scrapers to move from the first pre-set operative state to the second operative state. Advantageously, the controller can adjust the operative state of the at least one of the one or more scrapers such that a desired state of the at least one of the one or more scrapers is achieved for given operational conditions. It will be appreciated that what is described with respect to the at least one of the one or more scrapers can also apply to the plurality of scrapers (i.e. the plurality of scrapers may be together moved from the first state to the second state).

For example, in a period where the conveyor belt is conveying a reduced amount of material (or substantially no material at all), the controller may receive an input signal to this effect and determine that a change in the operative state of the at least one of the one or more scrapers is necessary. The controller may then send an output signal causing a change from the first pre-set operative state of the at least one of the one or more scrapers to the second operative state. In this example, the change may relate to a change in the desired orientation of the at least one of the one or more scrapers—in particular, the orientation of the at least one of the one or more scrapers may be relaxed such that there is a reduction in contact between the at least one of the one or more scrapers and the conveyor belt. This can significantly reduce belt and blade wear. It will be appreciated that what is described with respect to the at least one of the one or more scrapers can also apply to the plurality of scrapers (i.e. the plurality of scrapers may be together moved from the first state to the second state).

In an embodiment, the scraper realignment system may further include a positioner operatively associated with the actuator. Preferably, the positioner is configured to move a moving part of the actuator, thereby moving the at least one of the one or more scrapers. Said movement of the at least one of the one or more scrapers may be achieved by moving the support (e.g. moving the support in the rotational direction). In an embodiment, the positioner is configured to move the moving part of the actuator, thereby moving the at least one of the one or more scrapers from the first pre-set operative state to the second operative state. In an embodiment, the positioner is configured to be in operative communication with the controller. Preferably, the positioner receives the at least one output signal from the controller. The positioner may be a pneumatic positioner, an electro-pneumatic positioner, or a digital valve positioner. It will be appreciated that what is described with respect to the at least one of the one or more scrapers can also apply to the plurality of scrapers (i.e. the plurality of scrapers may be together moved from the first state to the second state).

One advantage of at least one embodiment of the present invention is that the one or more scrapers (whether they be primary or secondary scrapers) could be adjusted automatically in order to maintain desired operational conditions, such as constant pressure and tip angle under challenging conditions.

In an embodiment, the one or more scrapers are secondary scrapers.

In another embodiment, the one or more scrapers are primary scrapers.

In an embodiment, at least one of the one or more scrapers include a body having a proximal mounting base and a distal scraping tip. The mounting base may include a first engagement formation configured to engage with a second engagement formation located on a support. In an embodiment, the support is a bar or shaft. The first engagement formation and the second engagement formation may be corresponding male and female members that are engaged or disengaged by rotation of the scraper relative to the support about a longitudinal axis of the support.

Preferably, the first engagement formation and the second engagement formation both extend helically around the longitudinal axis of the support.

The first engagement formation is preferably defined by a female channel formed in the mounting base, and the second engagement formation is preferably defined by a helical projection which extends radially away from the support in both circumferential and longitudinal directions.

The first engagement formation preferably includes a first locking formation, and the second engagement formation includes a second locking formation.

The first locking formation is preferably defined by a region of increased cross-sectional area located at or near a distal end of the first engagement formation.

The first engagement formation preferably has a generally circular cross-sectional area.

The second engagement formation preferably has a cross-sectional profile having a T-shaped appearance.

The proximal mounting base preferably includes a curved recess extending in a direction which is parallel with the longitudinal axis of the support, the curved recess having a cross-sectional profile in the form of a segment of a circle, and corresponding with an outer diameter of the support.

The support may include a plurality of support sections configured to be connected end to end with other like support sections. Preferably, the support is a shaft assembly and includes a plurality of shaft sections configured to be connected end to end with other like shaft sections.

The shaft sections are preferably connected end to end with corresponding male and female engagement formations.

Each shaft section is preferably provided as an open collar having a longitudinally extending channel.

The shaft assembly preferably includes an internal shaft configured to be located within the shaft sections.

The internal shaft preferably includes a longitudinally extending rib configured to engage with the longitudinally extending channel of each shaft section.

The conveyor belt scraper assembly further preferably comprises a locking block mounted to one of the shaft sections and configured to abut against an end scraper to prevent the scraper from moving relative to the shaft section.

The locking block is preferably provided in the form of a generally rectangular prism, with a curved channel formed on an underside, the curved channel is configured to abut with the shaft section, such that the locking block is slidable relative to the shaft section parallel to a longitudinal axis, and the locking block can be selectively isolated relative to the shaft section.

A fastener preferably extends through a longitudinally extending slot formed in the locking block.

In a second aspect, the present invention provides a conveyor belt scraper assembly, including:
one or more scrapers;
a support configured to support said one or more scrapers;
a scraper realignment system configured to move at least one of the one or more scrapers from a first state to a second state, wherein movement of said at least one of the one or more scrapers is in a substantially rotational direction.

In an embodiment, the one or more scrapers are primary scrapers.

In another embodiment, the one or more scrapers are secondary scrapers.

It will be appreciated that what is described with respect to the at least one of the one or more scrapers can also apply to the plurality of scrapers (i.e. the plurality of scrapers may be together moved from the first state to the second state).

It will be appreciated that features disclosed with respect to the first aspect of the invention are also applicable with respect to the second aspect of the invention, including different combinations of features disclosed.

In a third aspect, the present invention provides a method of operating a conveyor belt scraper assembly, the conveyor belt scraper assembly including:
one or more scrapers;
a support configured to support said one or more scrapers;
a scraper realignment system configured to move at least one of the one or more scrapers from a first state to a second state;
   the method including:
receiving one or more input signals, wherein the one or more input signals relate to one or more of: conveyor belt speed, presence of material on conveyor belt, vibration of scraper(s), and pressure on scraper(s);
transmitting at least one output signal based on said one or more input signals, said at least one output signal causing at least one of the one or more scrapers to move from the first state to the second state.

In an embodiment, the first state is a first pre-set operative state and the second state is a second operative state.

In an embodiment, the scraper realignment system includes an actuator, wherein the actuator is configured to move the at least one of the one or more scrapers from the first pre-set operative state to or towards the second operative state. Movement of said at least one of the one or more scrapers is preferably in the rotational direction (or substantially in the rotational direction). The actuator is preferably operatively secured to the support.

In an embodiment, the scraper realignment system includes a controller operatively associated with the actuator. The controller may be configured to receive said one or more input signals. The controller may be configured to transmit said at least one output signal.

In an embodiment, the scraper realignment system includes a positioner operatively associated with the actuator.

The method may further include receiving said at least one output signal, and moving the at least one of the one or more scrapers from the first state to the second state. Preferably, the positioner receives said at least one output signal, and affects movement of the at least one of the one or more scrapers from the first state to the second state.

It will be appreciated that features disclosed with respect to the first and second aspects of the invention are also applicable with respect to the third aspect of the invention, including different combinations of features disclosed.

It will be appreciated that what is described with respect to the at least one of the one or more scrapers can also apply to the plurality of scrapers (i.e. the plurality of scrapers may be together moved from the first state to the second state).

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of a conveyor belt scraper assembly in accordance with an embodiment of the present invention, said embodiment showing a primary scraper application;

FIG. 2 is a perspective view of a primary scraper of the conveyor belt scraper assembly of FIG. 1;

FIG. 3 is a perspective view of the support of the conveyor belt scraper assembly of FIG. 1, although only a truncated form of the support is shown;

FIG. 4 is a perspective view of the support of FIG. 3 with shaft end mounts shown disassembled from a shaft;

FIG. 5 is a perspective view of a section of the conveyor belt scraper assembly of FIG. 1, particularly showing the scraper realignment system;

FIG. 6 is a perspective view of a conveyor belt scraper assembly in accordance with another embodiment of the present invention, said embodiment showing a secondary scraper application;

FIG. 7 depicts a pair of secondary scrapers mounted on a support;

FIG. 8 is a side cross-sectional view of a secondary scraper of FIG. 6; and

FIG. 9 is a perspective view of a section of the conveyor belt scraper assembly of FIG. 6, particularly showing the scraper realignment system.

### DETAILED DESCRIPTION OF THE EMBODIMENTS

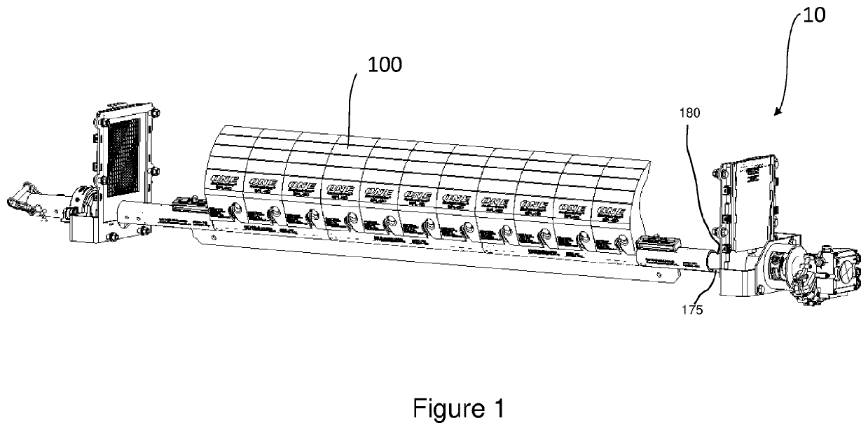

Reference is made to FIGS. 1-5 that illustrate a conveyor belt scraper assembly 10 in accordance with an embodiment of the present invention. In this embodiment, scrapers 100 are primary scrapers.

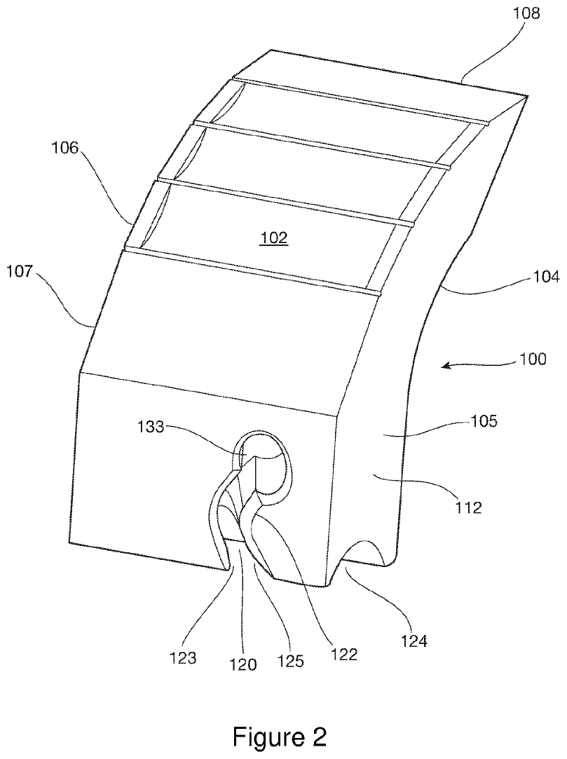

Referring to FIG. 2, a primary conveyor belt scraper 100 is depicted in isolation. The conveyor belt scraper 100 has a longitudinally extending body 102, with two side walls 105, 107 that are generally parallel. The body 102 has a concave side 104 and a convex side 106. The concave and convex sides 104 and 106 converge at the scraping tip 108. In use, the primary conveyor belt scraper 100 is positioned adjacent to the location where the conveyor belt changes direction. The convex side 106 is generally facing upward, such that scraped coal (or other conveyed material) is directed away from the belt by the scraping tip 108, and passes across the convex side 106.

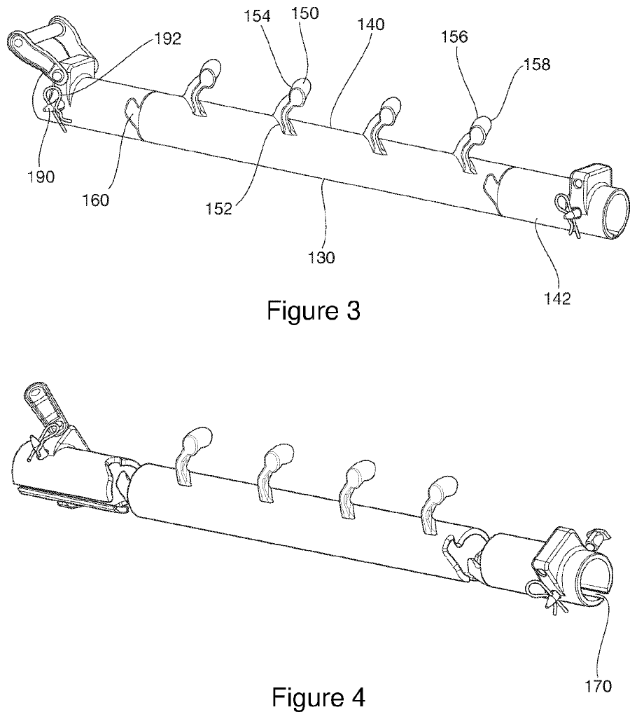

The primary conveyor belt scraper 100 includes a mounting base 112. The mounting base 112 is located at the proximal end of the scraper 100 which is furthest from the scraping tip 108. The mounting base 112 includes a first engagement formation 120 configured to secure the mounting base 112 to a shaft assembly or bar 130 (FIG. 3).

The underside of the primary conveyor belt scraper 100 includes a curved recess 124. The curvature is in the form of a segment of a circle, and corresponds with the dimension of the radius of the shaft 130.

The first engagement formation 120 is defined by a channel 122. In a preferred embodiment, the channel 122 is helical, such that the channel 122 extends diagonally through the mounting base 112 between the channel entry slot 125 located on the convex side 106, and the end of the channel 122 which terminates adjacent to the concave side 104. The channel 122 is a blind channel, meaning it does not pass completely through the mounting base 112, but terminates close to the concave side 104. Although described and depicted herein as a helical channel 122, it will be appreciated that the channel could alternatively be circumferential.

The primary conveyor belt scraper 100 is fabricated from a polymer (e.g. polyurethane), and in this embodiment has no internal support members or stiffening components. Other suitable materials for fabrication of scraper 100 include a reinforced polymer (such as polyurethane with a tool steel or tungsten reinforcement), rubber, suitable metals, etc.

A proximal end 123 of the channel 122 is located closest to the shaft 130. The channel 122 has a distal end having a first locking formation, which in the embodiment of FIG. 2 is defined by a region of increased cross-sectional area. The region of increased cross-sectional area is generally circular aperture 133 which also follows a radial extension of the helical path defined by the channel 122. It will be appreciated that the locking formation may be provided in other shapes, and it is not limited to a circle. The locking formation simply provides a mechanism to prevent the second engagement formation (discussed below) of the shaft 130 from being radially retracted from the channel 120.

With reference to FIG. 3, a single shaft section 140 of the shaft 130 is depicted along with opposing shaft end mounts 142. It will be appreciated that there may be one or more shaft sections 140 that form the overall shaft 130 (as would be evident from FIG. 1). The shaft end mounts 142 are used to secure the shaft 130 relative to the conveyor belt. The shaft 130 may be resiliently secured with a damping system (not shown), typically in the form of air bags or springs. The damping system enables the shaft 130 to be temporarily deflected, generally in a translation direction, if a large load is applied to one or more of the scrapers 100, to reduce the likelihood of scraper blade damage. As will be described in further detail below, the damping system forms part of a scraper realignment system.

The shaft 130 is modular and may be formed by connecting a plurality of similar shafts sections 140. The shaft sections 140 can be added to either longitudinal end, which enables a long shaft 130 to be assembled within a limited area. It also enables the shaft 130 to be retracted from the lateral side of the conveyor belt in stages, even when there is minimal clearance. This is desirable in some conveyor belt installations, such as in underground mining operations where there is often limited clearance at the side of the conveyor belt, meaning that any shaft maintenance or scraper maintenance/replacement must be performed in front of the conveyor belt which is undesirable.

Each shaft section 140 includes a second engagement formation 150. The second engagement formation 150 is provided in the form of a helical projection which extends radially away from the shaft section 140. The helix is also longitudinally extending. The proximal end 152 of the second engagement formation 150 is attached to the shaft section 140, and the distal end 154 of the second engagement formation 150 is located furthest from the shaft section 140. The distal end 154 includes a second locking formation 156 in the form of a rib 158 having a generally circular cross-sectional area. The rib 158 is sized to fit within the circular aperture 133.

The second engagement formation 150 is sized to be complementary with the first engagement formation 120. As such, it will be appreciated that the specific shapes of the first and second engagement formations 120, 150 may vary and are not limited to those described and depicted herein.

Whilst the conveyor belt scraper 100 has been described in the context of the first engagement formation 120 being male, and the second engagement formation 150 being female, it will be appreciated that the invention could alternatively be embodied in the contrary sense, such that the female formation is located on the shaft 130.

To engage the first engagement formation 120 with the second engagement formation 150, the curvature of the shaft 130 is seated against the curved recess 124 located on the underside of the mounting base 112. By inserting the second engagement formation 150 into the first engagement formation in the form of the channel entry slot 125, the shaft 130 and scraper 100 are brought into engagement. By further rotating the conveyor belt scraper 100, it rotates helically around and along the longitudinal axis of the shaft 130.

Each shaft section 140 is provided as an open collar with a longitudinally extending channel 170 (FIG. 4), when viewed through a plane extending perpendicular to a longitudinal axis. At each end of each shaft section 140, the shaft section 140 has a connector 160, and there is a male connector located at one end and a corresponding female connector located at the opposing end. The connectors 160 enable the shaft sections 140 to be connected end to end. The connectors 160 are male and female, and complementary in shape. The shaft sections 140 are seated on an internal shaft 180, as shown in FIG. 1. The internal shaft 180 has a longitudinally extending rib 175 which is configured to lock and engage with the channel 170. When the internal shaft 180 is located within a pair of longitudinally interconnected shaft sections 140, the engagement between the channel 170 and the rib 175 serves the purpose of preventing rotation of the internal shaft 180 relative to the external shaft sections 140. Furthermore, this also serves the purpose of preventing the connectors 160 from being decoupled, as decoupling can only be performed by moving the adjacent shaft sections 140 in a direction that is generally perpendicular to a longitudinal axis of shaft 130, and that movement is not possible while the internal shaft 180 is internally located. It will be appreciated that the adjacent shaft sections 140 may be coupled in a different manner to that described above. For example, the adjacent shaft sections 140 may be coupled with bayonet type male and female formations that engage when rotated about a longitudinal axis.

When a technician wishes to replace one or more of the conveyor belt scrapers 100, the opposing shaft end mounts 142 are decoupled from the support and damping device to which they are attached. Referring to FIG. 3, the cotter pin 192 and locking pin 190 are removed. This decouples the internal shaft 180 and the external shaft sections 140, enabling them to be moved axially relative to each other. As each set of engaged connectors 160 moves beyond the end of the underlying internal shaft 180, the connectors 160 are free to be decoupled by moving the shaft section 140, which is no longer located around the internal shaft 180, in a lateral direction.

This enables the conveyor belt scrapers 100 to be removed or changed in a relatively small clearance, typically only requiring a lateral clearance adjacent to the conveyor belt being slightly larger than the length of the individual shaft sections 140.

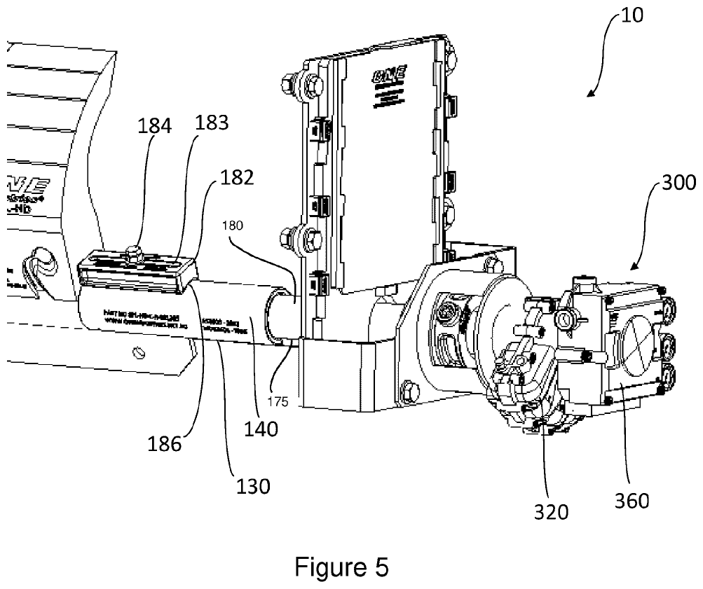

With reference to FIG. 5, a locking block 182 may be provided. The locking block 182 is secured to one of the individual shaft sections 140 with a bolt 184. The bolt passes through a longitudinally extending slot formed 183 in the locking block 182, and engages with a threaded hole (not shown) formed in the shaft section.

The locking block 182 is provided in the form of a generally rectangular prism, with a curved channel 186 formed on an underside thereof. The curved channel 186 is configured to abut in a complementary manner with the shaft section 140. The locking block 182 is slidable relative to the shaft section 140 parallel to a longitudinal axis thereof. Tightening the bolt 184 results in the locking block 182 being secured in position relative to the shaft section 140. In operation, the locking block 182 is secured at a position where it will abut against the conveyor belt scrapers 100. This securement prevents the end scraper in the row (and hence each adjacent scraper) from being released relative to the shaft section 140 during use, because the end conveyor belt scraper 100 needs to move axially as well as rotationally when it is removed.

In order to remove the end conveyor belt scraper 100, the bolt 184 is loosened to enable the axial movement of the locking block 182 relative to the shaft section 140, away from the conveyor belt scraper 100.

During operation, scrapers 100 can be translationally and rotationally displaced when a large load is applied to one or more of scrapers 100. This large load can be a result of the scrapers contacting the conveyor belt during typical scraping or, more likely, contacting an obstruction on the surface of the conveyor belt (e.g. sections of the belt having fasteners or material that has not been removed). Displacement of one or more of scrapers 100 can reduce the overall efficiency of the scraping process. For example, the scraper may be displaced such that it is no longer in a desired state (i.e. no longer in the desired position and/or orientation). This can result in reduced or sub-optimal scraping.

As best shown in FIG. 5, conveyor belt scraper assembly 10 includes a scraper realignment system 300, which is configured to move scrapers 100 from a first state to a second state. In one case, the first state can be a disrupted state and the second state can be a pre-set operative state (the ‘reactive’ case). In another case, the first state can be a first pre-set operative state and the second state can be a second operative state (the ‘proactive’ case). Movement of scrapers 100 can be in a translational direction and a rotational direction.

As previously described, translational movement of the scrapers 100 is provided by the damping system, which enables the shaft 130 to be temporarily deflected if a large load is applied to one or more of the scrapers 100. Deflection of shaft 130 results in a corresponding movement of the scrapers 100 from their pre-set operative state to the disrupted state. This is generally in the form of a movement in position of scrapers 100. As the damping system is biased such that the scrapers 100 are arranged in their pre-set operative state, once the temporary load is removed, scrapers 100 are returned from the disrupted state to the pre-set operative state. Thus, scraper realignment system 300 can move scrapers 100 in a translational direction from the disrupted state to the pre-set operative state.

In various circumstances, one or more of scrapers 100 may be rotationally displaced due to a large load being applied to one or more of the scrapers 100. In such a circumstance, the disrupted state of scraper 100 is provided by way of a change in the orientation of the scraper (with or without a change in position). For example, scraper 100 may be arranged such that in a pre-set operative state it is oriented at about 85° to 95° with respect to the conveyor belt. After being impacted by the load, scraper 100 is moved so that it is oriented at a different angle with respect to the conveyor belt. In known prior art systems, the conveyor belt would need to be stopped and the scraper would then usually need to be accessed and manually moved back to the pre-set operative state. In contrast, scraper realignment system 300 includes an actuator 320, which is operatively secured to shaft 130, that is configured to move the at least one of the one or more scrapers 100 from the disrupted state to the pre-set operative state. As will be described further below, actuator 320 can also be configured to move the at least one of the one or more scrapers 100 from the first pre-set operative state to the second operative state. This is achieved by moving shaft 130 (and thus the at least one of the one or more scrapers 100) in a rotational direction. The rotational direction is therefore about an axis substantially perpendicular to a direction of travel of the conveyor belt, and in this case parallel to a longitudinal axis of shaft 130. Thus, through operatively securing actuator 320 to shaft 130, shaft 130 can be temporarily angularly displaced if a large load is applied to the at least one of the one or more scrapers 100, and then shaft 130 can be moved so that the at least one of the one or more scrapers 100 moves from the disrupted state to the pre-set operative state (the ‘reactive’ case).

It will be appreciated that in the above example, given the earlier defined engagement between scrapers 100 and shaft 130, all of scrapers 100 would be rotationally displaced given that the earlier defined arrangement does not allow separate rotation of one scraper with respect to the others. Accordingly, movement of shaft 130 in the rotational direction would result in all of scrapers 100 moving from the disrupted state to the pre-set operative state.

Actuator 320 is in the form of a rotary vane pneumatic actuator. A suitable rotary vane pneumatic actuator includes the Kinetrol™ Vane Actuator. The actuator is connected to a pressurised gas circuit (not shown). When scrapers 100 and shaft 130 are rotationally displaced by a load on the scraper 100, the moving part of actuator 320 (i.e. the internal vane within actuator 320, not shown) is rotated away from its pre-set position (defined by a set pressure). Once the load is removed, the vane rotates back to its pre-set position, thereby rotating shaft 130 (and hence scrapers 100) back to their pre-set operative state. Thus, scraper realignment system 300 enables at least one of the one or more scrapers 100 (in the present example, all scrapers 100 supported by shaft 130) to be moved back to its pre-set operative state when the state of the scraper is altered (in the disrupted state here). In particular, scraper realignment system 300 is capable of moving the scraper in a translational direction and a rotational direction depending on what is required to move scraper 100 from the disrupted state back to the pre-set operative state. Depending on the load encountered, scraper realignment system 300 can move scraper 100 in a translational direction, a rotational direction or both a translational direction and rotational direction.

The above description relates to the scraper realignment system's capability to move scrapers 100 from a disrupted state back to the pre-set operative state. However, scraper realignment system 300 is also capable of moving the scrapers from a first pre-set operative state to a second operative state (the ‘proactive’ case). This can be based on changing operational conditions.

Realignment system 300 includes a controller (not shown) operatively associated with actuator 320. The controller is configured to receive at least one input signal, but preferably multiple input signals, from various sensors (not shown) installed in the overall conveyor belt assembly, of which conveyor belt scraper assembly 10 is a part. The input signals can relate to one or more of conveyor belt speed, presence of material on conveyor belt, vibration (belt and scraper vibration), blade wear, spray bar water consumption (if spray bar included in conveyor assembly), and pressure on the scraper. The controller is further configured to send at least one output signal causing a change in the pre-set operative state of scrapers 100 to a different operative state (herein the second operative state).

Realignment system 300 further includes a positioner 360 operatively associated with actuator 320. A suitable positioner includes the VRC™ electro-pneumatic positioner. The positioner 360 is configured to move the moving part of actuator 320, thereby rotating shaft 130 and thus scrapers 100 in order to change the orientation of the scrapers 100. Positioner 360 is in the form of an electro-pneumatic positioner, whereby varying the applied current moves the moving part of the actuator and hence the rotating shaft 130 and scrapers 100. It will be appreciated that positioner 360 may instead be any other suitable form of positioner. Positioner 360 is in operative communication with the controller, and specifically receives the one or more output signals from the controller and effects the change of moving scrapers 100 from the first pre-set operative state to the second operative state. In some embodiments, the controller forms part of positioner 360.

From the one or more input signals, the controller is programmed to determine whether to move the scrapers from the first pre-set operative state to the second operative state. If a change is to be effected, the controller sends one or more output signals to positioner 360 and positioner 360 moves scrapers 100 as described above.

For example, if the conveyor belt speed is increased, an input signal from a sensor measuring conveyor belt speed can be sent to the controller. The controller may be programmed to output a signal to positioner 360 to move the scrapers from the existing (first) pre-set operative state to the second operative state such as changing the orientation of the scrapers to a relatively more relaxed angle to the conveyor belt. In another example, if the conveyor belt is carrying a relatively reduced amount of material, an input signal from a sensor (such as a laser or radar sensor) can be sent to the controller. The controller may be programmed to output a signal to positioner 360 to move scrapers 100 from the existing pre-set operative state to the second operative state such as changing the orientation of the scrapers to a relatively more relaxed angle to the conveyor belt given less material is going to be encountered. Various other situations may be encountered that result in a change in the orientation of scrapers 100 being effected (be it a relaxing of the angle or providing a more aggressive angle).

In view of the above, it will be appreciated that the scraper realignment system 300 can be used to move the scrapers from an existing (first) pre-set operative state to a second operative state depending on the operational conditions. This greatly assists in reducing blade and belt wear in conditions where the scraper does not need to be so aggressively oriented relative to the conveyor belt. This therefore also reduces operational downtime and therefore increases efficiency of the scraping process.

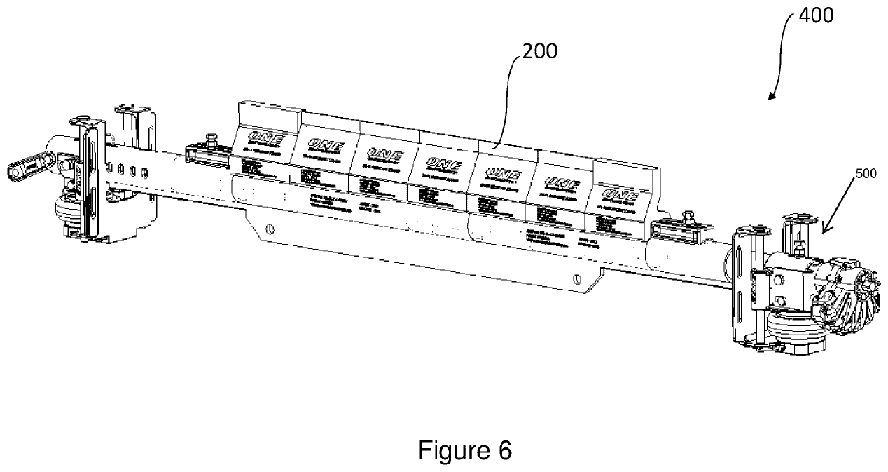

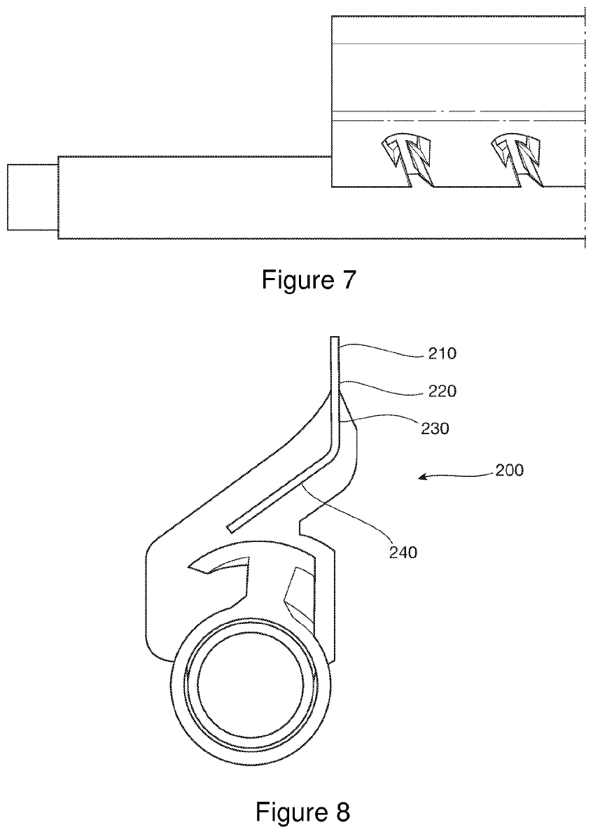

Reference is now made to FIGS. 6-9 that illustrate a conveyor belt scraper assembly 400 in accordance with another embodiment of the present invention. In this embodiment, scrapers 200 are secondary scrapers, which are intended for placement below the conveyor belt, on the return path. The mounting arrangement and general operation of conveyor belt scraper assembly 400 is very similar to conveyor belt scraper assembly 10. The points of difference will be discussed below. In particular, referring to FIG. 7, the shape of the first and second engagement formations is generally T-shaped in cross-section. However, a helical path is still followed having both circumferential and axial displacement as the scraper 200 moves toward or away from the locked position.

In the embodiments described above, the path followed by the scraper 100, 200 when engaging with or disengaging from the shaft sections 140 is helical. However, it will be appreciated that in an alternative embodiment, the path may be circumferential only, such that the second engagement formation 150 extends in a circumferential but not longitudinal direction. In that embodiment, the scraper 100, 200 does not move linearly relative to the shaft section 140 during engagement or disengagement.

With reference to FIG. 8, the secondary conveyor belt scraper 200 includes a metallic scraper tip 210 which is integrally formed with an internal stiffening element 220. The stiffening element 220 is bent such that it has a first planar portion 230 and a second planar portion 240 that are angularly offset relative to each other by an angle in the range of about 100 degrees to 150 degrees, and most preferably of about 120 degrees to 135 degrees. The stiffening element 220 provides the scraper tip 210 but also enables the body of the scraper 200 to be sufficiently rigid to scrape the conveyor belt, but remains compliant enough to flex if the scraper tip 210 encounters a solid object.

In the embodiments depicted in the drawings, each conveyor belt scraper 100, 200 is described as having a single first engagement formation 120 defined by a channel 122, it will be appreciated that two or more channels 122 may be provided in each scraper 100, 200.

The conveyor belt scrapers 100, 200 are described as having parallel sides 105, 107 extending generally orthogonal to the front and rear curved surfaces 104, 106. However, in an alternative arrangement, the parallel sides 105, 107 may alternatively extend generally parallel to the direction that the helical path defined by the channel 122.

Conveyor belt scraper assembly 400 includes a scraper realignment system 500, which is configured to move scrapers 200 from a first state to a second state in much the same way as described with respect to scraper realignment system 300. Movement of scrapers 200 can therefore be in a translational direction and/or a rotational direction as previously described.

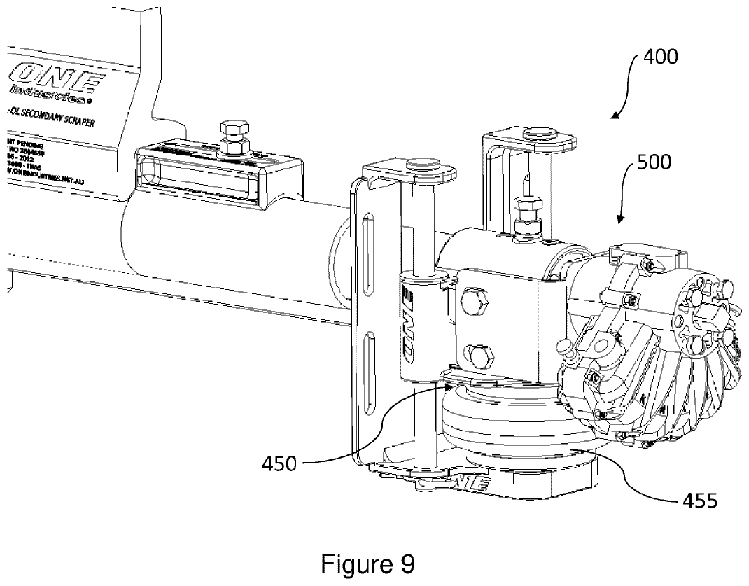

FIG. 9 best shows an example of a damping system configured to enable the shaft 130 to be temporarily deflected, generally in a translation direction, if a large load is applied to one or more of the scrapers 200, and further configured to move the shaft (and therefore scrapers 200) in a translation direction back to their original position. Damping system 450 includes an air cushioning system 455. It will be appreciated that other forms of damping system may be used. The shaft 130 is resiliently secured with the damping system 450 as earlier described. FIG. 9 does not show the positioner. It will be understood that conveyor belt scraper assemblies 10, 400 need not have the positioner, thereby only enabling scrapers 100, 200 to be moved from a disrupted state to the pre-set operative state.

It will be understood that the damping system of conveyor belt scraper assembly 10 can be the same as damping system 450, or it could be a different form of damping system.

The secondary conveyor belt scrapers 200 may be fabricated from a reinforced polymer (e.g. polyurethane with a tool steel or tungsten reinforcement. However, other suitable materials for fabrication of scraper 200 include a non-reinforced polymers, rubber, suitable metals, etc.

It will be understood that the invention disclosed and defined in this specification extends to all alternative combinations of two or more of the individual features mentioned or evident from the text or drawings. All of these different combinations constitute various alternative aspects of the invention.

1. A conveyor belt scraper assembly, including:
one or more scrapers;
a support configured to support said one or more scrapers;
a scraper realignment system configured to move at least one of the one or more scrapers, from a first state to a second state, wherein movement of said at least one of the one or more scrapers can be in a substantially translational direction and a substantially rotational direction.

2. The conveyor belt scraper assembly of claim 1, wherein:
the first state is a first pre-set operative state of said one or more scrapers and the second state is an altered state of said one or more scrapers, wherein said altered state is a second operative state of said one or more scrapers; or
the second state is a pre-set operative state of said one or more scrapers and the first state is an altered state of said one or more scrapers, wherein said altered state is a disrupted state of said one or more scrapers.

3. The conveyor belt scraper assembly of claim 2, wherein the scraper realignment system is configured to move the at least one of the one or more scrapers, from the disrupted state to the pre-set operative state and/or from the first pre-set operative state to the second operative state, or
wherein the first pre-set operative state and the pre-set operative state are an initial pre-set operative state of the one or more scrapers.

4. (canceled)

5. The conveyor belt scraper assembly of claim 3, wherein the initial pre-set operative state of the one or more scrapers includes a first desired position and/or a first desired orientation of the one or more scrapers.

6. The conveyor belt scraper assembly of claim 5, wherein the first desired position of the one or more scrapers is a predetermined position whereby the one or more scrapers contact the conveyor belt in a desired manner, and the first desired orientation of the one or more scrapers is defined by the scraper being oriented at a predetermined angle relative to the conveyor belt.

7. (canceled)

8. The conveyor belt scraper assembly of claim 2, wherein the altered state of the one or more scrapers includes a second, altered position and/or a second, altered orientation of the one or more scrapers.

9. The conveyor belt scraper assembly of claim 8, wherein the second, altered position of the one or more scrapers is a position translationally displaced from the first desired position, and/or the second, altered orientation of the one or more scrapers is defined by the scraper being angularly displaced from the predetermined angle.

10. The conveyor belt scraper assembly of claim 2, wherein the scraper realignment system includes a damping system, wherein the damping system is configured to move the at least one of the one or more scrapers from:
the disrupted state to or towards the pre-set operative state, wherein said movement of said at least one of the one or more scrapers is substantially in the translational direction; or
from the first pre-set operative state to or towards the second operative state, wherein said movement of said at least one of the one or more scrapers is substantially in the translational direction.

11. The conveyor belt scraper assembly of claim 10, wherein the damping system is resiliently secured to the support, thereby enabling the support and the at least one of the one or more scrapers to be temporarily displaced if a large load is applied to the at least one of the one or more scrapers, and to move the at least one of the one or more scrapers back to or towards the pre-set operative state from the disrupted state.

12. The conveyor belt scraper assembly of claim 10, wherein the damping system includes one or more springs and/or an air cushioning system.

13. The conveyor belt scraper assembly of claim 2, wherein the scraper realignment system includes an actuator configured to move the at least one of the one or more scrapers from:
the disrupted state to or towards the pre-set operative state, wherein movement of said at least one of the one or more scrapers is substantially in the rotational direction; and/or
the first pre-set operative state to or towards the second operative state, wherein movement of said at least one of the one or more scrapers is substantially in the rotational direction.

14. The conveyor belt scraper assembly of claim 13, wherein the actuator is operatively secured to the support.

15. The conveyor belt scraper assembly of claim 14, wherein the actuator includes one or more of an electrical actuator, a pneumatic actuator or a hydraulic actuator.

16. The conveyor belt scraper assembly of claim 13, wherein the scraper realignment system includes a controller operatively associated with the actuator, wherein the controller is configured to receive at least one input signal, said at least one input signal relating to one or more of: conveyor belt speed, presence of material on conveyor belt, vibration of scraper, and pressure on scraper, and to transmit at least one output signal based on said at least one input signal, said at least one output signal causing at least one of the one or more scrapers to move from the first state to the second state.

17. The conveyor belt scraper assembly of claim 16, wherein said at least one output signal causes the at least one of the one or more scrapers to move from the first pre-set operative state to the second operative state.

18. The conveyor belt scraper assembly of claim 16, wherein the scraper realignment system includes a positioner operatively associated with the actuator, said positioner configured to move a moving part of the actuator, thereby moving the at least one of the one or more scrapers.

19. The conveyor belt scraper assembly of claim 18, wherein said moving the at least one of the one or more scrapers is achieved by moving the support in the rotational direction.

20. The conveyor belt scraper assembly of claim 19, wherein the positioner is configured to be in operative communication with the controller, wherein the positioner receives the at least one output signal from the controller.

21. The conveyor belt scraper assembly of claim 18, wherein the positioner is a pneumatic positioner, an electro-pneumatic positioner, or a digital valve positioner.

22. The conveyor belt scraper assembly of claim 1, wherein the one or more scrapers are primary scrapers of the conveyor belt scraper assembly, or wherein the one or more scrapers are secondary scrapers of the conveyor belt scraper assembly.

23-24. (canceled)

25. The conveyor belt scraper assembly of claim 1, wherein the scraper realignment system is configured to move each of the one or more scrapers from the first state to the second state.

26. The conveyor belt scraper assembly of claim 25, wherein said movement of each of the one or more scrapers is achieved by moving the support in the rotational direction.

27-29. (canceled)
